(19) United States
(12) Patent Application Publication
(10) Pub. No.: US 2026/0319856 A1
(43) Pub. Date: Oct. 15, 2026

(54) ELECTRONIC DEVICE AND OPERATING METHOD THEREOF

(71) Applicant: SAMSUNG ELECTRONICS CO., LTD., Suwon-si (KR)

(72) Inventors: Kyeonghwan JUNG, Suwon-si (KR); Gwanggyun JEONG, Suwon-si (KR); Changhyeon CHAE, Suwon-si (KR); Kyungmin KANG, Suwon-si (KR); Iksoon KIM, Suwon-si (KR); Jihoon KIM, Suwon-si (KR); Jihun JUNG, Suwon-si (KR); Youngho CHOI, Suwon-si (KR)

(21) Appl. No.: 19/689,715

(22) Filed: May 27, 2026

Related U.S. Application Data
(63) Continuation of application No. PCT/KR2024/017432, filed on Nov. 6, 2024.

(30) Foreign Application Priority Data
Nov. 30, 2023 (KR) 10-2023-0171535

(51) Int. Cl. G06F 9/50; G06F 11/30; G06F 11/34

(52) U.S. Cl. CPC G06F 9/5038; G06F 9/505; G06F 11/3024; G06F 11/3433

(57) ABSTRACT

An electronic device for monitoring system load, example embodiments may include: a memory for storing at least one instruction; and at least one processor for executing the at least one instruction. The at least one processor may: determine the priority of at least one task; determine whether to monitor system load on the basis of the priority of the at least one task; and output monitoring data. The system load can include at least one from among CPU contention, IO wait, wake-up delay and system resource usage.

### CROSS-REFERENCE TO RELATED APPLICATIONS

This application is a continuation application of International Application No. PCT/KR2024/017432, filed on Nov. 6, 2024, in the Korean Intellectual Property Receiving Office, and claiming priority to KR Application No. 10-2023-0171535, filed Nov. 30, 2023, the disclosures of which are all hereby incorporated by reference herein in their entireties.

### TECHNICAL FIELD

Various example embodiments may relate to an electronic device for monitoring system load and/or an operating method thereof.

### BACKGROUND

As electronic devices such as smart phones become more powerful, various services using the electronic devices are being provided. For example, applications that provide high-level services using artificial intelligence (AI) technology, such as Bixby and Internet of Things (IoT) via electronic devices are being increasingly applied. Applications used on these smart platforms may be referred to as an application.

Recently, while application execution performance has improved along with the enhanced performance of electronic devices, the application entry speed may become slower in case of executing applications with large resources in some cases. Further, the entry time may increase due to the execution of various computational tasks and resources required during an initial execution of an application. Furthermore, the application entry speed may increase in proportion to the usage time of the electronic device, and may be slower than usual in case that there is a heavy background load depending on the system situation. To address this, various optimization efforts have recently been made in the framework and kernel domains, and scheduling may be utilized as one of them. Here, the scheduling may refer to a program function that determines when and how much limited system resources are to be allocated to various tasks.

### SUMMARY

Various example embodiments may provide an electronic device and/or an operating method thereof that minimize a load required for monitoring system load by determining a priority of at least one task based on Cgroup and monitoring system load generated by processing of a high priority of at least one task.

An electronic device for monitoring system load according to certain example embodiments may include memory storing at least one instruction and at least one processor executing the at least one instruction. Each “processor” herein comprises processing circuitry, and may comprise one or more processors. The at least one processor may determine a priority of at least one task, determine whether to monitor system load based on the priority of the at least one task, and output monitoring data. The system load may include at least one of CPU contention, IO wait, wake-up delay, or usage of system resource.

According to an embodiment, the at least one processor may determine whether the priority of the at least one task is equal to or higher than a preset reference priority using a Cgroup module, in a kernel domain, and generate monitoring data for the system load using a system monitoring module, in case that the priority of the at least one task is equal to or higher than the reference priority.

According to an embodiment, the at least one processor may determine the priority of a first task and a second task using the Cgroup module, and monitor the CPU contention between the first task and the second task in case that the priority of at least one of the first task or the second task is equal to or higher than the reference priority.

According to an embodiment, the at least one processor may identify a start of CPU contention in case that the second task preempts a head of a run queue where the first task maintained in a running state is located, identify an end of CPU contention in case that the first task is located at the head of the run queue again, and output CPU contention monitoring data including at least one of the start of CPU contention, an end of CPU contention, the priority of the first task, or the priority of the second task.

According to an embodiment, the at least one processor may determine the priority of the first task based on the first task generating a block IO request, and monitor the IO wait for the first task in case that the priority of the first task is equal to or higher than the reference priority.

According to an embodiment, the at least one processor may identify a start of IO wait in case of inserting the block IO request of the first task into an IO queue, switch the first task to a sleep state in case that there is a block IO request of the second task in the IO queue, switch the first task to a wake-up state in case that the block IO request of the first task in the IO queue is processed, identify an end of IO wait in case that the first task is located at the head of the run queue, and output IO wait monitoring data including at least one of the start of IO wait, the end of IO wait, the priority of the first task, or the block IO request of the first task.

According to an embodiment, the at least one processor may determine the priority of the first task based on a wake-up request of the first task in a sleep state, and monitor the wake-up delay for the first task, in case that the priority of the first task is equal to or higher than the reference priority.

According to an embodiment, the at least one processor may switch the first task to a wake-up state, identify a start of the wake-up delay in case that the first task is inserted into the run queue, identify an end of the wake-up delay in case that the first task is located at the head of the run queue, and output wake-up delay monitoring data including at least one of the start of wake-up delay, the end of wake-up delay, or the priority of the first task.

According to an embodiment, the at least one processor may monitor the usage of the system resource corresponding to the at least one task in case that the priority of the at least one task is equal to or higher than the reference priority, and output system resource usage data including CPU usage within a predetermined time after system booting.

According to an embodiment, the at least one processor may sort the system resource in descending order of usage using a red-black tree (RB tree).

According to an embodiment, the at least one processor may store command information of the at least one task in a radix tree, update the usage of the system resource at every predetermined period, and retrieve the system resource usage data corresponding to the command information using the radix tree upon a request for a usage inquiry for the system resource.

According to an embodiment, the at least one processor may perform data filtering on the monitoring data based on at least one of a type of the at least one task, the priority of the at least one task, Cgroup to which the at least one task belongs, or a magnitude of the system load, and output the filtered monitoring data based on a user input.

A method for monitoring system load according to example embodiments may include determining a priority of at least one task, determining whether to monitor the system load based on the priority of the at least one task, and outputting monitoring data. The system load may include at least one of CPU contention, IO wait, wake-up delay, or usage of a system resource.

According to an embodiment, an operation of determining the priority of the at least one task may determine, in a kernel domain, whether the priority of the at least one task is equal to or higher than a preset reference priority using a Cgroup module. An operation of determining whether to monitor the system load may generate monitoring data for the system load using a system monitoring module, in case that the priority of the at least one task is equal to or higher than the reference priority.

According to an embodiment, the operation of determining the priority of the at least one task may include determining the priority of a first task and a second task using the Cgroup module. The operation of determining whether to monitor the system load may include monitoring the CPU contention between the first task and the second task in case that the priority of at least one of the first task or the second task is equal to or higher than the reference priority. The operation of monitoring the CPU contention may include identifying a start of CPU contention, in case that the second task preempts a head of a run queue where the first task maintained in a running state is located; identifying an end of CPU contention in case that the first task is located at the head of the run queue again; and generating CPU contention monitoring data including at least one of the start of CPU contention, the end of CPU contention, the priority of the first task, or the priority of the second task.

According to an embodiment, the operation of determining the priority of the at least one task may include determining the priority of the first task based on the first task generating a block IO request. The operation of determining whether to monitor the system load may include monitoring the IO wait for the first task, in case that the priority of the first task is equal to or higher than the reference priority. The operation of monitoring the IO wait may include identifying a start of IO wait in case of inserting the block IO request of the first task into an IO queue, switching the first task to a sleep state in case that there is the block IO request of a second task in the IO queue, switching the first task to a wake-up state in case that the block IO request of the first task in the IO queue is processed, identifying an end of IO wait in case that the first task is located at the head of a run queue, and generating IO wait monitoring data including at least one of the start of IO wait, the end of IO wait, the priority of the first task, or the block IO request of the first task.

According to an embodiment, the operation of determining the priority of the at least one task may include determining the priority of the first task based on a wake-up request of the first task in a sleep state. The operation of determining whether to monitor the system load may include monitoring the wake-up delay for the first task, in case that the priority of the first task is equal to or higher than the reference priority. The operation of monitoring the wake-up delay may include switching the first task to a wake-up state, identifying a start of wake-up delay in case that the first task is inserted into a run queue, identifying an end of wake-up delay in case that the first task is located at the head of the run queue, and generating wake-up delay monitoring data including at least one of the start of wake-up delay, the end of wake-up delay, or the priority of the first task.

According to an embodiment, the operation of determining whether to monitor the system load may include monitoring the usage of the system resource corresponding to the at least one task, in case that the priority of the at least one task is equal to or higher than the reference priority. The operation of monitoring the usage of the system resource may include generating system resource usage data including CPU usage within a predetermined time after system booting.

According to an embodiment, the operation of monitoring the usage of the system resource may sort the system resources in descending order of the usage using an RB tree.

According to an embodiment, the operation of monitoring the usage of the system resource may store command information of the at least one task in a radix tree, update the usage of the system resource at every predetermined period, and retrieve the system resource usage data corresponding to the command information using the radix tree, upon a request for a usage inquiry for the system resource.

According to various example embodiments, an electronic device for monitoring system load and an operating method thereof may determine a priority of at least one task based on Cgroup and monitor system load generated by processing of the at least one task with high priority.

Accordingly, an example electronic device for monitoring system load and the operating method thereof may increase the use efficiency of system resources by minimizing the overhead required in monitoring system load.

Effects that can be obtained from example embodiments of the disclosure are not limited to those mentioned above, and other effects not mentioned herein may be clearly derived and understood by those having ordinary knowledge in the technical field to which the example embodiments of the disclosure belong from the following description. In other words, any unintended effects of implementing the example embodiments of the disclosure may also be derived by those having ordinary knowledge in the technical field from the example embodiments of the disclosure.

### BRIEF DESCRIPTION OF DRAWINGS

FIG. 1 illustrates a block configuration of an electronic device in a network environment according to an embodiment.

FIG. 2 illustrates a block configuration of an electronic device according to an embodiment.

FIG. 3 illustrates a block configuration of at least one processor according to an embodiment.

FIG. 4 illustrates an operating sequence of an electronic device according to an embodiment.

FIG. 5 illustrates a CPU contention monitoring process of an electronic device according to an embodiment.

FIG. 6 illustrates an operating sequence of CPU contention monitoring of an electronic device according to an embodiment.

FIG. 7 illustrates an IO wait monitoring process of an electronic device according to an embodiment.

FIG. 8 illustrates an operating sequence of IO wait monitoring of an electronic device according to an embodiment.

FIG. 9 illustrates a wake-up delay monitoring process of an electronic device according to an embodiment.

FIG. 10 illustrates an operating sequence of wake-up delay monitoring of an electronic device according to an embodiment.

FIG. 11 illustrates a monitoring process for usage of system resources of an electronic device according to an embodiment.

FIG. 12 illustrates an operating sequence for monitoring usage of system resources of an electronic device according to an embodiment.

### DETAILED DESCRIPTION

Hereinafter, embodiments of the disclosure will be described in detail with reference to the drawings such that a person having ordinary knowledge in the technical field to which the disclosure belongs may easily implement the embodiments. However, the disclosure may be implemented in various different forms and is not limited to the embodiments described herein. In relation to the description of the drawings, the same or similar reference numerals may be used for the same or similar components. Further, in the drawings and related description, the descriptions of well-known functions and configurations may be omitted for clarity and brevity.

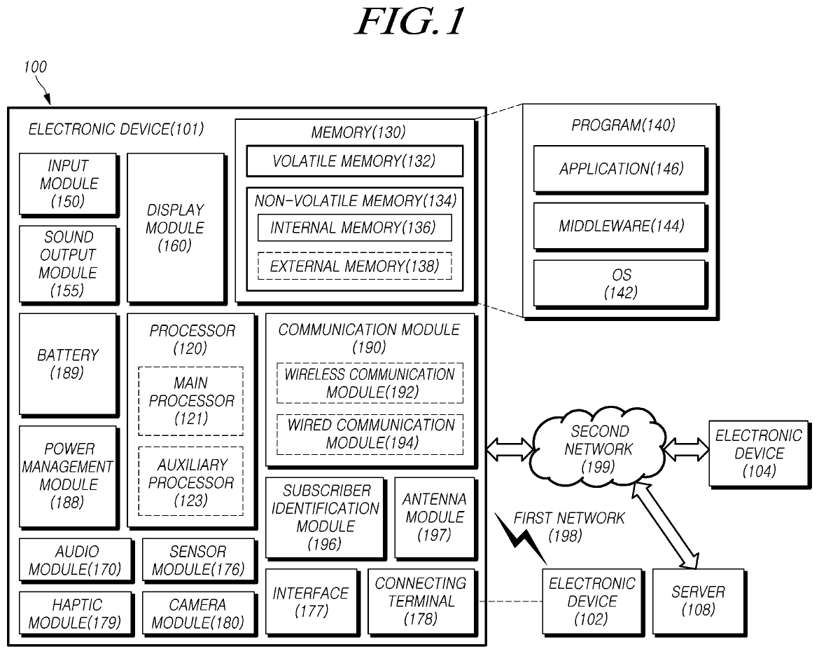

FIG. 1 illustrates a block configuration of an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected, directly or indirectly, with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology and/or IoT-related technology.

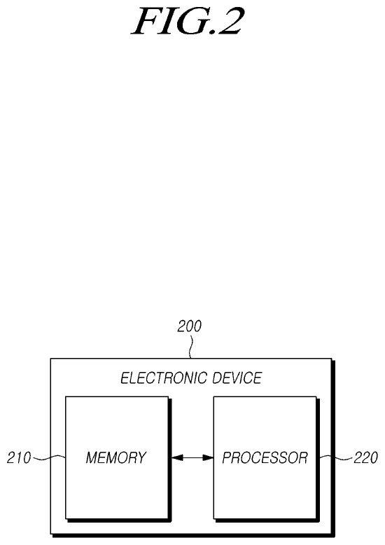

FIG. 2 illustrates a block configuration of an electronic device 200 according to an embodiment.

The electronic device 200 of the present disclosure may be implemented as a display device capable of displaying an image. For example, the electronic device 200 may include at least one of a television (TV), a computer, a smartphone, a tablet computer, a portable media player, a wearable device, a video wall, or an electronic frame. Further, the electronic device may be implemented as various types of electronic devices, such as an image processing device like a set-top box without a display, home appliances like a refrigerator or a washing machine, or an information processing device like a computer main body. Hereinafter, for convenience of explanation, it is assumed that the electronic device is implemented as a TV, but the electronic device of the disclosure is not limited thereto and may be also applied to various electronic devices such as a set-top box instead of a TV.

Referring to FIG. 2, the electronic device 200 according to an embodiment of the present disclosure may include a memory 210 and a processor 220. The memory 210 may store data while power is supplied. The memory 210 may include a volatile storage component in which data is lost in case that power is not supplied. For example, the memory 210 may include at least one of a buffer or a random access memory (RAM).

The memory 210 of the present disclosure may include physical memory and virtual memory. Upon execution of a program, predetermined data may be loaded into the memory 210 for each task of a process corresponding to the program. Data or software required for execution by the processor 220 among the data or software stored in storage may be loaded into the memory 210.

The memory 210 may include a general memory area where general processes are allocated and a kernel memory area where a kernel such as an operating system is allocated. Each area of the general memory and the kernel memory may be concentrated or distributed in any storage space of the memory 210. In an embodiment, the processor 220 may allocate general processes to a spare portion of the kernel memory excluding a portion where the operating system is allocated.

A process corresponding to a program may be allocated to and operated in the memory 210. Meanwhile, a process may share some of the allocated memory with another process. Therefore, even although one process is erased, the shared memory may not be secured. Even though the execution of the program is terminated, the process allocated to the memory 210 may remain until it is erased from the memory 210.

Meanwhile, the memory 210 according to an embodiment of the present disclosure may be provided integrally or may be different memories, and is not limited to either one.

The processor 220 may execute a program stored in storage. The processor 220 may be implemented as at least one processor that loads at least a portion of a program from the storage where the program is stored into the memory 210 and executes the program loaded in the memory 210. In case that the processor 220 of the present embodiment is implemented as a plurality of processors, these processors may be separate from each other or may be implemented in the form of a plurality of modules in one IC.

For example, the processor 220 may include at least one of a central processing unit (CPU), an application processor (AP), or a microprocessor. In case that the processor 220 executes a program stored in storage, predetermined data corresponding to each task of a corresponding process may be loaded into the memory 210, so that the corresponding process enters a state of occupying a specific area of the memory 210. The processor 220 may first load data regarding the process into the memory 210 and execute the process based on the data loaded in the memory 210. For example, a process may be a unit of task executed based on data or an application loaded in the memory 210. That is, one or more processes may be performed by the processor 220 processing data loaded in the memory 210 or executing an application loaded in the memory 210. In order for a process to be executed, data corresponding to the process may need to be loaded in the memory 210. For example, multi-tasking may be performed by the processor 220 executing data for each process loaded in the memory 210, with data corresponding to a plurality of processes being loaded in the memory 210.

The processor 220 according to an embodiment of the present disclosure may be implemented by executing a software program including one or more instructions stored in a storage medium readable by a machine such as the electronic device 200. For example, the processor 220 of the electronic device may call at least one instruction among one or more stored instructions from the storage medium and execute the same. The one or more instructions may include codes generated by a compiler or codes executable by an interpreter. The machine-readable storage medium may be provided in the form of a non-transitory storage medium. Here, the term ‘non-transitory’ only means that the storage medium is a tangible device and does not include a signal (e.g., electromagnetic waves), and this term does not distinguish between a case where data is semi-permanently stored in the storage medium and a case where it is temporarily stored.

In an embodiment, a program executed by the processor 220 may be implemented as a computer program stored in a computer program product as provided separately from the electronic device 200. In such a case, the computer program product may include a memory in which instructions corresponding to the computer program are stored and a processor. As such, the electronic device may perform an operation of the processor 220 by downloading and executing the computer program stored in the separate computer program product.

Further, in an embodiment, the operation of the processor 220 may be implemented as a computer-readable program stored on a recording medium. A program stored on a recording medium, e.g., data may be directly accessed and executed by the processor 220, or may be downloaded into and executed on the electronic device via a transmission medium implemented over a wired/wireless network in which computer systems are interconnected, thereby performing the operation.

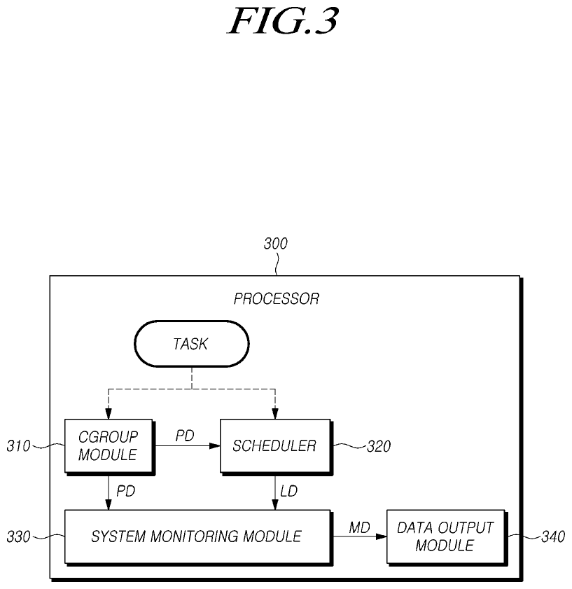

The processor 220 according to an embodiment of the present disclosure may determine a priority of at least one task based on a Cgroup and monitor system load based on the priority. For example, the processor 220 may determine the priority of at least one task, monitor system load generated by processing of at least one task with a high priority based on the priority of the at least one task, and output monitoring data. Hereinafter, a specific process in which the electronic device of the present disclosure monitors system load will be described with reference to FIGS. 3 to 12.

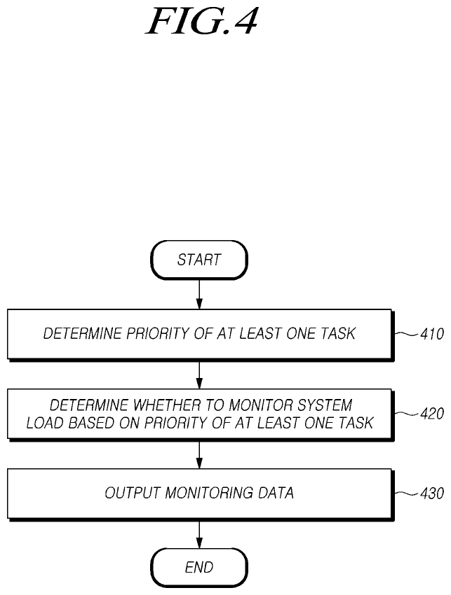

FIG. 3 illustrates a block configuration of at least one processor 300 according to an embodiment, and FIG. 4 illustrates an operating sequence of an electronic device according to an embodiment.

Referring to FIGS. 3 and 4, the electronic device may determine a priority of at least one task (operation 410), determine whether to monitor system load based on the priority of the at least one task (operation 420), and output monitoring data MD (operation 430). Processes and threads processed by the processor 300 may be scheduled as at least one task within a scheduler. For example, the at least one task may refer to one scheduling unit of a predetermined process. The system load may include at least one of CPU contention, IO wait, wake-up delay, or usage of a system resource. For example, the electronic device may monitor at least one of the CPU contention, the IO wait, the wake-up delay, or the usage of a system resource based on the priority of at least one task.

In an embodiment, the processor 300 may include at least one of a Cgroup module 310, a scheduler 320, a system monitoring module 330, or a data output module 340.

The Cgroup module 310 may provide a function of distributing system resources. For example, the Cgroup module 310 may group at least one task and manage the use of system resources in a group unit of the at least one task. For example, the Cgroup module 310 may determine the priority of at least one task.

In an embodiment, the Cgroup module 310 may group at least one task into a plurality of control groups and distribute the system resources to the plurality of control groups. For example, the plurality of control groups may include a foreground control group and a background control group. For example, the foreground control group may include an application executed in the foreground. For example, the background control group may include an application or a service executed in the background. A larger amount of CPU resources may be allocated to the foreground control group compared to the background control group. Accordingly, while applications in the foreground may be executed in a smooth manner, applications or services in the background may be restricted in smooth execution due to a lack of CPU resources.

The scheduler 320 may allocate the time of the processor 300 to at least one task. For example, the scheduler 320 may schedule a task to be processed based on the priority and execution readiness state of the at least one task. For example, the scheduler 320 may include at least one of an RT scheduler or a CFS scheduler.

In an embodiment, the RT (Real-Time) scheduler may be a scheduler using a Real-Time scheduling scheme to preempt CPU resources based on the priority. The Real-Time scheduling scheme may be used for real-time tasks with the highest priority. In the Real-Time scheduling scheme may be used a FIFO (first in first out or first come first served) policy that first allocates the CPU resources to a process prepared first, or a Round Robin policy that allows processes to use the CPU resources in order.

In an embodiment, the CFS scheduler may be a scheduler using a CFS scheduling scheme for fairly allocating CPU resources. The CFS scheduling scheme may be used for tasks with a lower priority than that of real-time tasks. The CFS scheduling scheme may be used to allocate CPU resources to tasks (e.g., processes and threads) included in each control group based on a usage of CPU resources determined for each control group (or Cgroup). A Round Robin policy may be used in the CFS scheduling scheme.

The system monitoring module 330 may monitor system load generated by processing of at least one task. The system monitoring module 330 may generate monitoring data MD. For example, the monitoring data MD may include at least one of CPU contention monitoring data, IO wait monitoring data, wake-up delay monitoring data, or system resource usage data. The system monitoring module 330 may transmit the monitoring data MD to the data output module 340.

The data output module 340 may output the monitoring data MD to at least one of a user interface, a log file, or a database. For example, the data output module 340 may perform data filtering on the monitoring data MD and output the filtered monitoring data MD based on a user input.

According to an example, in operation 410, the electronic device may determine a priority of at least one task. The Cgroup module 310 included in the processor 300 may provide a distribution function for system resources. For example, the Cgroup module 310 may determine the priority of at least one of a predetermined process, a predetermined thread, or a predetermined task. The priority of the at least one task may include the importance of the at least one task and the degree of interest in the at least one task. For example, in a kernel domain, the Cgroup module 310 may determine whether the priority of the at least one task is equal to or higher than a preset reference priority. Here, the reference priority may be set by a user input.

The Cgroup module 310 may group at least one task into a plurality of control groups and distribute system resources to the plurality of control groups. For example, as shown in Table 1 below, the plurality of control groups may include at least one of a first control group, a second control group, a third control group, or a fourth control group.

TABLE 1

| | First Control | Second Control | Third Control | Fourth Control |
|---|---|---|---|---|
| | Group (Service | Group (Foreground | Group (Normal | Group (Background |
| | Control Group) | Control Group) | Control Group) | Control Group) |
| Priority | 2 | 1 | 3 | 4 |
| Resource | e.g., 20% | e.g., 70% | e.g., 7% | e.g., 3% |
| Allocation | | | | |
| Ratio | | | | |

The first control group may be a service control group. The second control group may be a foreground control group. The third control group may be a normal control group. The fourth control group may be a background control group. The priorities associated with system resource allocation (e.g., CPU resource allocation) may be higher in the order of the second control group, the first control group, the third control group, and the fourth control group. According to an example, as the priorities become higher, a system resource allocation ratio (e.g., CPU resource allocation ratio) may become larger. For example, a task included in the first control group be allocated a system resource at a lower ratio than tasks included in the second control group running in the foreground, but may be allocated system resources at a higher ratio than tasks included in the fourth control group running in the background.

The Cgroup module 310 may transmit priority data PD including the priority of at least one task to the scheduler 320. The Cgroup module 310 may transmit the priority data PD including the priority of at least one task to the system monitoring module 330.

According to an example, in operation 420, the electronic device may determine whether to monitor system load based on the priority of at least one task. The system monitoring module 330 included in the processor 300 may receive priority data PD including the priority of at least one task from the Cgroup module 310. The system monitoring module 330 may receive load data LD required for processing the at least one task from the scheduler 320. The system monitoring module 330 may determine whether to monitor system load based on the priority of the at least one task and the load data LD. For example, the system monitoring module 330 may monitor system load, in case that the priority of the at least one task is equal to or higher than a reference priority. In an embodiment, the reference priority may be a second priority. For example, in case that the reference priority is the second priority, the system monitoring module 330 may monitor system load, in case that the at least one task is included in at least one of the first control group (e.g., service control group) or the second control group (e.g., foreground control group). For example, in case that the reference priority is the second priority, the system monitoring module 330 may not monitor system load, in case that the at least one task is included in at least one of the third control group (e.g., normal control group) or the fourth control group (e.g., background control group). The system monitoring module 330 may monitor at least one of CPU contention, IO wait, wake-up delay, or usage of a system resource, based on the priority of the at least one task. The system monitoring module 330 may generate monitoring data MD including at least one of CPU contention monitoring data, IO wait monitoring data, wake-up delay monitoring data, or system resource usage data. The system monitoring module 330 may transmit the monitoring data MD to the data output module 340.

According to an example, in operation 430, the electronic device may output the monitoring data MD. The data output module 340 included in the processor 300 may receive the monitoring data MD from the system monitoring module 330. The data output module 340 may output the monitoring data MD to at least one of a user interface, a log file, or a database. The data output module 340 may perform data filtering on the monitoring data MD. For example, the data output module 340 may filter the monitoring data MD based on at least one of a type of the at least one task, the priority of the at least one task, the Cgroup to which the at least one task belongs, or a magnitude of the system load. For example, the monitoring data MD may be data-filtered based on whether the at least one task is a process or a thread. For example, the monitoring data MD may be data-filtered based on a type (e.g., RT scheduler, CFS scheduler) of the scheduler 320. For example, the monitoring data MD may be data-filtered based on a delay time according to the system load. The data output module 340 may output the filtered monitoring data MD based on a user input. For example, the data output module 340 may output the filtered monitoring data MD based on a user input to at least one of a user interface, a log file, or a database.

As such, the electronic device according to an embodiment of the present disclosure may determine a priority of at least one task based on the Cgroup, monitor system load generated by processing of the at least one task with high-priority, and output monitoring data MD. Accordingly, the electronic device of the present disclosure may increase efficiency of using system resources by minimizing an overhead required to monitor system load.

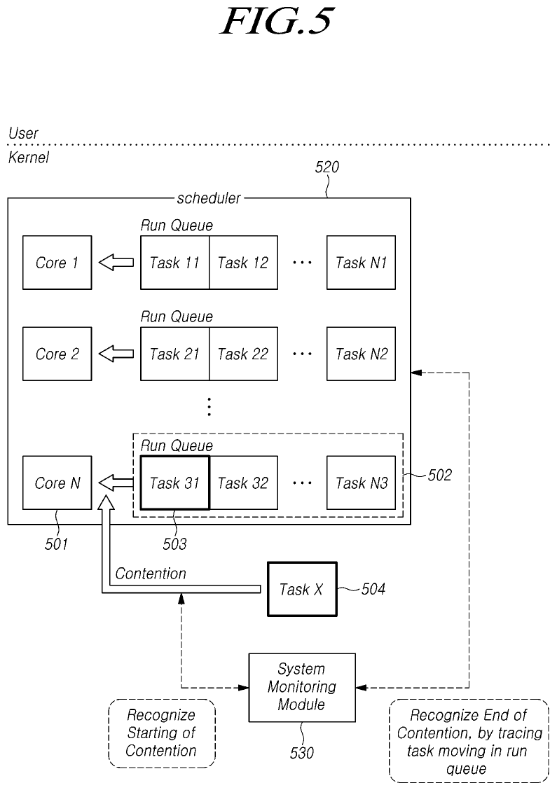

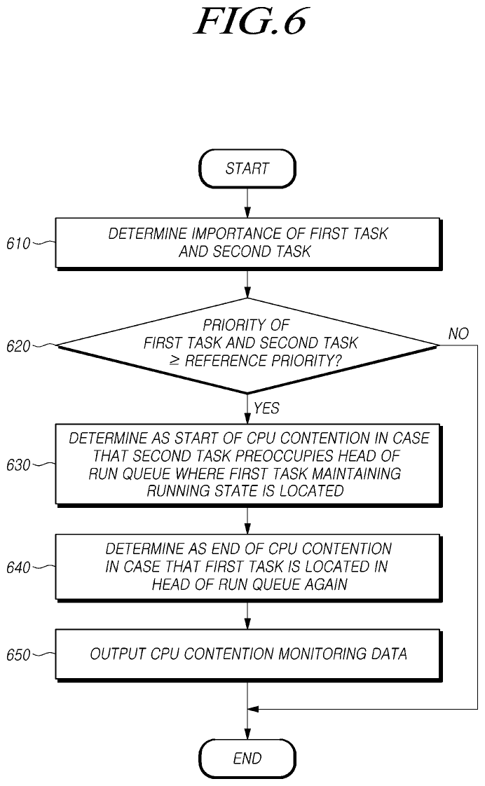

FIG. 5 illustrates a CPU contention monitoring process of an electronic device according to an embodiment, and FIG. 6 illustrates an operating sequence for CPU contention monitoring of an electronic device according to an embodiment.

Referring to FIGS. 5 and 6, the electronic device may determine the priority of a first task and a second task using the Cgroup module (operation 610), and in case that the priority of at least one of the first task or the second task is equal to or higher than a reference priority, may monitor the CPU contention between the first task and the second task (operation 620 to operation 640), and output CPU contention monitoring data (operation 650).

According to an example, in operation 610, the electronic device may determine the priority of a first task and a second task using the Cgroup module (e.g., Cgroup module 310 in FIG. 3). The scheduler 520 may include a plurality of run queues (run queue) corresponding to a plurality of cores. For example, the scheduler 520 may include an N-th run queue corresponding to an N-th core. Based on scheduling of the scheduler 520, a plurality of tasks may be sequentially located in the N-th run queue. For example, a first task (e.g., Task 31 (503)) may be located at a head of the N-th run queue to preempt the N-th core. Here, CPU contention may occur between the first task (e.g., Task 31 (503)) and a second task (e.g., Task X (504)). The CPU contention may refer to system resource competition in which a plurality of tasks (e.g., processes or threads) compete to occupy a system resource (e.g., CPU resource). The Cgroup module included in the processor 300 may determine the priority of the first task (e.g., Task 31 (503)) and the second task (e.g., Task X (504)), which are targets of CPU contention. The priority may include the importance and degree of interest of the first task (e.g., Task 31 (503)) and the second task (e.g., Task X (504)). According to an example, in operation 620, the electronic device may determine whether

the priorities of the first task (e.g., Task 31 (503)) and the second task (e.g., Task X (504)) are equal to or higher than a preset reference priority. For example, in a kernel domain, the Cgroup module may determine whether the priorities of the first task (e.g., Task 31 (503)) and the second task (e.g., Task X (504)) are equal to or higher than the preset reference priority. Here, the reference priority may be set by a user input. The Cgroup module may transmit priority data PD including the priorities of the first task (e.g., Task 31 (503)) and the second task (e.g., Task X (504)) to the scheduler 520. The Cgroup module may transmit the priority data PD including the priorities of the first task (e.g., Task 31 (503)) and the second task (e.g., Task X (504)) to a system monitoring module 530. In case that the priorities of the first task (e.g., Task 31 (503)) and the second task (e.g., Task X (504)) are equal to or higher than the preset reference priority, the system monitoring module 530 may monitor CPU contention between the first task (e.g., Task 31 (503)) and the second task (e.g., Task X (504)).

According to an example, in operation 630, the electronic device may identify a start of CPU contention in case that the second task (e.g., Task X (504)) preempts the N-th core 501. For example, the system monitoring module 530 may identify the start of CPU contention in case that the second task (e.g., Task X (504)) preempts a head of a run queue 502 where the first task (e.g., Task 31 (503)) maintaining a running state is located. For example, the system monitoring module 530 may generate CPU contention monitoring data including the start of CPU contention.

According to an example, in operation 640, the electronic device may identify an end of CPU contention in case that the first task (e.g., Task 31 (503)) preempts the N-th core 501 again. For example, the system monitoring module 530 may monitor the movement of a plurality of tasks within the run queue 502, and identify the end of CPU contention in case that the first task (e.g., Task 31 (503)) is located at the head of the run queue 502 again. For example, the system monitoring module 530 may generate the CPU contention monitoring data including the end of CPU contention.

According to an example, in operation 650, the electronic device may output the CPU contention monitoring data. For example, a data output module (e.g., the data output module 340 in FIG. 3) may output the CPU contention monitoring data including at least one of the start of CPU contention, the end of CPU contention, the priority of the first task, or the priority of the second task. For example, the data output module may perform data filtering of the CPU contention monitoring data, based on at least one of a type of the at least one task, the priority of the at least one task, a Cgroup to which the at least one task belongs, or a magnitude of the system load. For example, the data output module may output the filtered CPU contention monitoring data to at least one of a user interface, a log file, or a database, based on a user input.

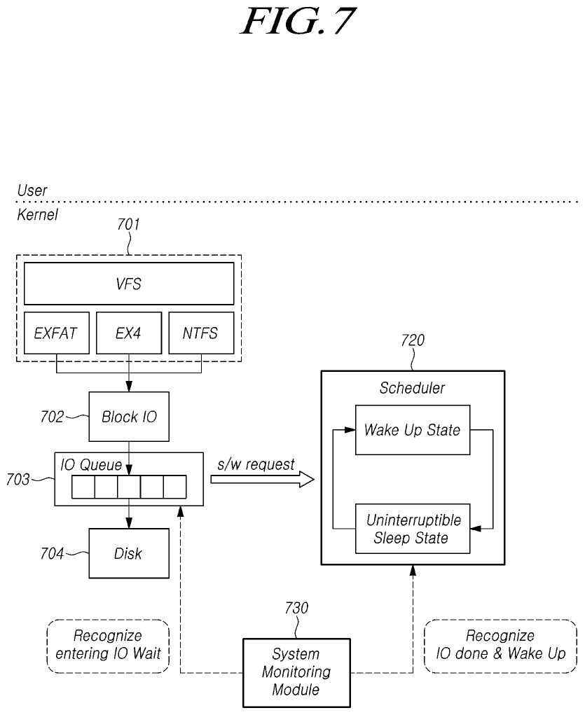

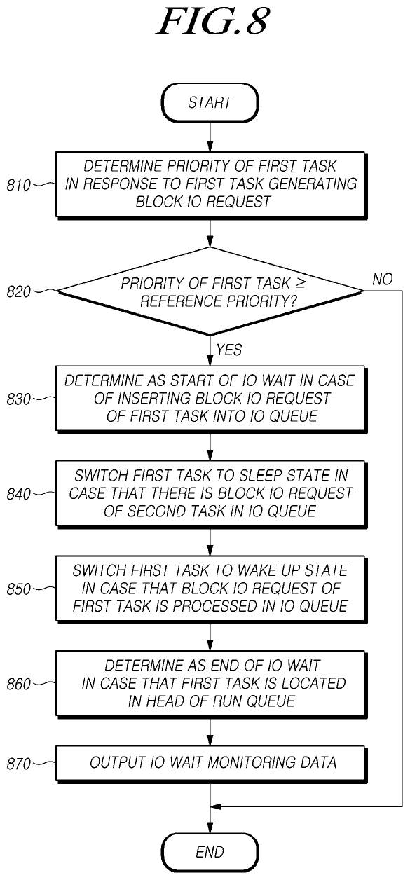

FIG. 7 illustrates an IO wait monitoring process of an electronic device according to an embodiment, and FIG. 8 illustrates an operating sequence for IO wait monitoring of an electronic device according to an embodiment.

Referring to FIGS. 7 and 8, the electronic device may determine the priority of a first task based on the first task generating a block IO request 702 (operation 810), and in case that the priority of the first task is equal to or higher than the reference priority, monitor the IO wait for the first task (operation 820 to operation 860) and output IO wait monitoring data (operation 870).

According to an example, in operation 810, the electronic device may determine the priority of the first task based on the first task generating a block IO request 702. The first task may generate the block IO request 702 based on a file system 701. In the process of processing the block IO request 702, an IO wait may occur according to a difference between a processing speed of a disk 704 and a processing speed of a CPU. The Cgroup module included in the processor 300 may determine the priority of the first task that generated the block IO request 702. The priority may include the importance and degree of interest of the first task.

According to an example, in operation 820, the electronic device may determine whether the priority of the first task is equal to or higher than a preset reference priority. For example, in a kernel domain, the Cgroup module may determine whether the priority of the first task is equal to or higher than the preset reference priority. Here, the reference priority may be set by a user input. The Cgroup module may transmit priority data PD including the priority of the first task to a scheduler 720. The Cgroup module may transmit the priority data PD including the priority of the first task to a system monitoring module 730. In case that the priority of the first task is equal to or higher than the preset reference priority, the system monitoring module 730 may monitor the IO wait for the first task.

According to an example, in operation 830, the electronic device may identify a start of IO wait in case of inserting the block IO request 702 of the first task into an IO queue 703. For example, the system monitoring module 730 may identify the start of IO wait in case that the block IO request 702 of the first task is inserted into the IO queue 703. For example, the system monitoring module 730 may generate IO wait monitoring data including the start of IO wait.

According to an example, in operation 840, in case that there is a block IO request 702 of a second task in the IO queue 703, the electronic device may switch the first task to a sleep state. For example, the block IO request 702 of the second task may have already been inserted into the IO queue 703 before the block IO request 702 of the first task. In such a case, the IO queue 703 may transmit a sleep request for the first task to the scheduler 720. The scheduler 720 may switch the first task to the sleep state based on the sleep request for the first task.

According to an example, in operation 850, in case that the block IO request 702 of the first task in the IO queue 703 is processed, the electronic device may switch the first task to a wake-up state. For example, in case that the block IO request 702 of the first task is processed, the IO queue 703 may transmit a wake-up request for the first task to the scheduler 720. The scheduler 720 may switch the first task to the wake-up state based on the wake-up request for the first task.

According to an example, in operation 860, the electronic device may identify an end of IO wait, in case that the first task occupies a core to which the first task belongs. For example, the system monitoring module 730 may identify the end of IO wait, in case that it is located at the head of the run queue. For example, the system monitoring module 730 may generate IO wait monitoring data including the end of IO wait.

According to an example, in operation 870, the electronic device may output the IO wait monitoring data. For example, a data output module (e.g., the data output module 340 of FIG. 3) may output the IO wait monitoring data including at least one of the end of IO wait, the priority of the first task, or the block IO request 702 of the first task. For example, the data output module may perform data filtering of the IO wait monitoring data, based on at least one of a type of the at least one task, the priority of the at least one task, the Cgroup to which the at least one task belongs, or a magnitude of the system load. For example, the data output module may output the filtered IO wait monitoring data to at least one of a user interface, a log file, or a database, based on a user input.

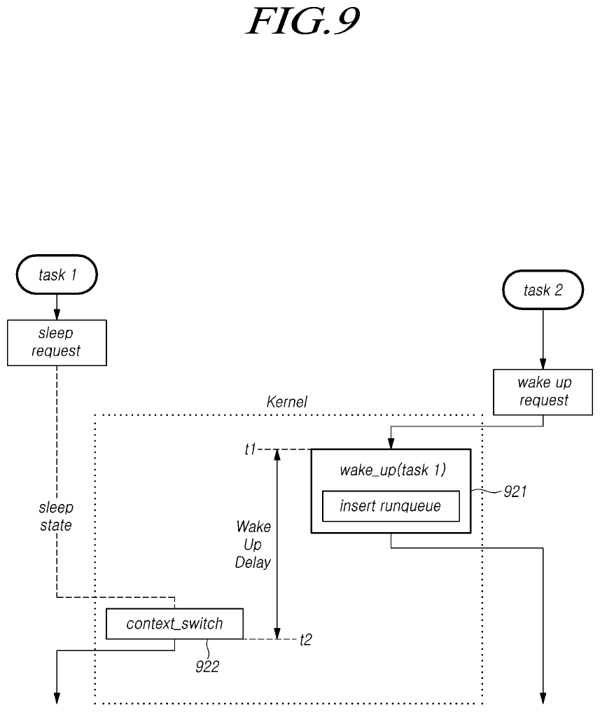

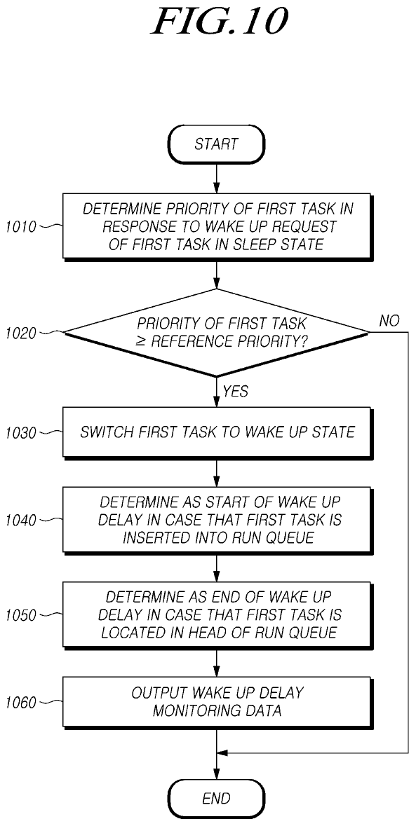

FIG. 9 illustrates a wake-up delay monitoring process of an electronic device according to an embodiment, and FIG. 10 illustrates an operating sequence of a wake-up delay monitoring of an electronic device according to an embodiment.

Referring to FIGS. 9 and 10, the electronic device may determine the priority of the first task based on a wake-up request of the first task in a sleep state (operation 1010), monitor the wake-up delay for the first task (operation 1020 to operation 1050) in case that the priority of the first task is equal to or higher than the reference priority, and output wake-up delay monitoring data (operation 1060). The wake-up delay may refer to a time delay occurring during a task switching process. For example, the wake-up delay may refer to a time delay from when a wake-up request for at least one task occurs up until context switching is completed.

According to an example, in operation 1010, the electronic device may determine the priority of the first task based on the wake-up request of the first task in the sleep state. In case that the first task is in the sleep state, the scheduler 921 may receive the wake-up request for the first task based on a scheduling request (e.g., signal input, event occurrence, unlock) of the second task. The Cgroup module included in the processor 300 may determine the priority of the first task in the sleep state. The priority may include the importance and degree of interest of the first task.

According to an example, in operation 1020, the electronic device may determine whether the priority of the first task is equal to or higher than a preset reference priority. For example, in a kernel domain, the Cgroup module may determine whether the priority of the first task is equal to or higher than the preset reference priority. Here, the reference priority may be set by a user input. The Cgroup module may transmit priority data PD including the priority of the first task to a scheduler 921. The Cgroup module may transmit the priority data PD including the priority of the first task to the system monitoring module (e.g., the system monitoring module 330 of FIG. 3). In case that the priority of the first task is equal to or higher than the preset reference priority, the system monitoring module may monitor the wake-up delay for the first task.

According to an example, in operation 1030 and operation 1040, the electronic device may switch the first task to a wake-up state, and in case that the first task is inserted into a run queue, the electronic device may identify a start of wake-up delay. For example, the scheduler 921 may switch the first task to the wake-up state based on the wake-up request. The first task switched to the wake-up state may be inserted into the run queue. The system monitoring module may identify the start of wake-up delay in case that the first task is inserted into the run queue (e.g., t1). For example, the system monitoring module may generate wake-up delay monitoring data including the start of wake-up delay.

According to an example, in operation 1050, the electronic device may identify an end of wake-up delay, in case that the first task occupies a core to which the first task belongs. For example, the system monitoring module may identify the end of wake-up delay in case that the first task is located at the head of the run queue. For example, in case that the first task is located at the head of the run queue and occupies the core (e.g., t2), switching of at least one task may occur in a scheduler 922. For example, the system monitoring module may generate wake-up delay monitoring data including the end of wake-up delay.

According to an example, in operation 1060, the electronic device may output the wake-up delay monitoring data. For example, the data output module (e.g., the data output module 340 in FIG. 3) may output the wake-up delay monitoring data including at least one of the start of wake-up delay, the end of wake-up delay, or the priority of the first task. For example, the data output module may perform data filtering of the wake-up delay monitoring data based on at least one of a type of the at least one task, the priority of the at least one task, the Cgroup to which the at least one task belongs, or a magnitude of the system load. For example, the data output module may output the filtered wake-up delay monitoring data to at least one of a user interface, a log file, or a database, based on a user input. “Based on” as used herein covers based at least on.

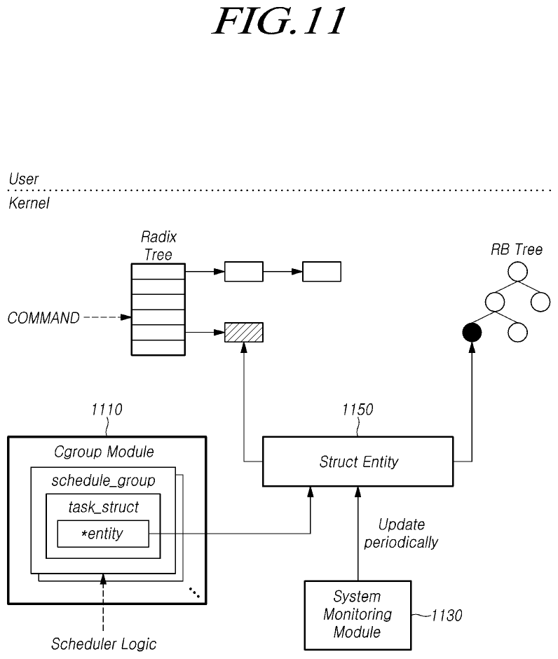

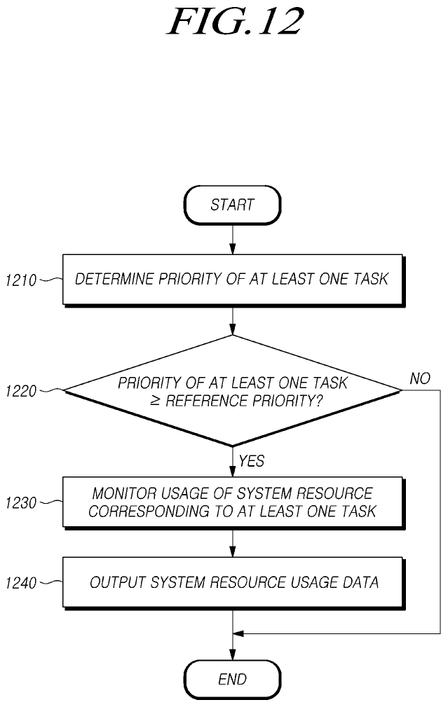

FIG. 11 illustrates a monitoring process for usage of system resources of an electronic device according to an embodiment, and FIG. 12 illustrates an operating sequence for monitoring usage of system resources of an electronic device according to an embodiment.

Referring to FIGS. 11 and 12, the electronic device may determine the priority of at least one task (operation 1210), monitor the usage of the system resource corresponding to the at least one task (operation 1220 and operation 1230) in case that the priority of the at least one task is equal to or higher than the reference priority, and output system resource data (operation 1240).

According to an example, in operation 1210, the electronic device may determine the priority of at least one task using the Cgroup module 1110. For example, the Cgroup module 1110 included in the processor 300 may determine the priority of at least one of a predetermined process, a predetermined thread, or a predetermined task. The priority of the at least one task may include the importance and degree of interest of the at least one task. For example, in a kernel domain, the Cgroup module 1110 may determine whether the priority of the at least one task is equal to or higher than a preset reference priority. Here, the reference priority may be set by a user input. The Cgroup module 1110 may transmit priority data PD including the priority of the at least one task to a scheduler (e.g., the scheduler 320 in FIG. 3).

According to an example, in operation 1220, the electronic device may determine whether the priority of the at least one task is equal to or higher than a preset reference priority. For example, in a kernel domain, the Cgroup module 1110 may determine whether the priority of the at least one task is equal to or higher than the preset reference priority. Here, the reference priority may be set by a user input. The Cgroup module 1110 may transmit priority data PD including the priority of the at least one task to the scheduler. The Cgroup module 1110 may transmit the priority data PD including the priority of the at least one task to a system monitoring module 1130.

According to an example, in operation 1230, the electronic device may monitor the usage of the system resource corresponding to the at least one task, in case that the priority of the at least one task is equal to or higher than the reference priority. For example, the system monitoring module 1130 may monitor CPU usage corresponding to the at least one task, in case that the priority of the at least one task is equal to or higher than the reference priority. For example, a structure entity 1150 included in the processor 300 may store CPU usage by at least one task in a predetermined time unit.

In an embodiment, the processor 300 may sort the system resources in descending order of the usage using an RB tree (Red Black Tree). For example, the structure entity 1150 may sort the CPU usage in descending order using the RB tree.

In an embodiment, the processor 300 may retrieve system resource usage data using a radix tree. For example, the structure entity 1150 may store command information of the at least one task in a radix tree. The system monitoring module 1130 may update the CPU usage using the structure entity 1150 at every predetermined cycle. Upon a request for querying CPU usage for the system resource, the structure entity 1150 may retrieve the system resource usage data (e.g., CPU usage data) corresponding to the command information using the radix tree. For example, the structure entity 1150 may retrieve CPU usage within a predetermined time after system booting (e.g., cold booting CPU usage).

According to an example, in operation 1240, the electronic device may output the system resource usage data. For example, a data output module (e.g., the data output module 340 in FIG. 3) may output the system resource usage data including CPU usage within a predetermined time after system booting. For example, the data output module may output the system resource usage data to at least one of a user interface, a log file, or a database.

As such, the electronic device according to an embodiment of the present disclosure may determine the priority of at least one task based on the Cgroup, monitor system load generated by processing of at least one task with high-priority, and output the monitoring data. Accordingly, the electronic device of the present disclosure may increase the efficiency of using system resources by minimizing the load involved in monitoring system load.

However, since the foregoing have been described above in detail, a redundant description thereof will be omitted.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

Various embodiments of this document and terms used herein are not intended to limit the technical features described in this document to specific embodiments, and should be understood to include various changes, equivalents, or substitutes of the corresponding embodiments. For example, a component expressed in the singular should be understood as a concept including a plurality of components unless the context clearly dictates only the singular. It should be understood that the term “and/or” used in this document encompasses any and all possible combinations of one or more of the listed items. Terms such as “comprise/include,” “have,” and “configured” used in the present disclosure are only intended to specify that features, components, parts, or combinations thereof described in the present disclosure exist, and the use of such terms does not exclude the possibility of the presence or addition of one or more other features, components, parts, or combinations thereof. In this document, each of the phrases such as “A or B,” “at least one of A and B,” “at least one of A or B,” “A, B, or C,” “at least one of A, B, and C,” and “at least one of A, B, or C” may include any one of the items listed together in the corresponding phrase, or all possible combinations thereof. Terms such as “first,” “second,” or “1st” or “2nd” may be used simply to distinguish a corresponding component from another corresponding component, and do not limit the corresponding components in other aspects (e.g., importance or order).

The term “~ unit” or “~ module” used in various embodiments of this document may include a unit implemented in hardware, software, or firmware, and may be used interchangeably with terms such as, for example, logic, logic blocks, parts, or circuits. A “~ unit” or “~ module” may be an integrally formed part or a minimum unit of the part or a portion thereof that performs one or more functions. For example, according to an embodiment, a “~ unit” or “~ module” may be implemented in the form of an ASIC (application-specific integrated circuit).

The term “in case that” used in various embodiments of this document may be interpreted to mean “when,” or “upon,” or “in response to determining,” or “in response to detecting,” depending on the context. Similarly, “in case that it is determined that” or “in case that something is detected” may be interpreted to mean “when determining” or “in response to determining,” or “when detecting” or “in response to detecting,” depending on the context.

A program executed by the electronic device 200 described throughout this document may be implemented by hardware components, software components, and/or a combination of hardware components and software components. The program may be executed by any system capable of performing computer-readable instructions.

Software may include a computer program, code, an instruction, or a combination of one or more thereof, and may configure a processing device to operate as desired or command the processing device independently or collectively. Software may be implemented as a computer program including instructions stored in computer-readable storage media (computer-readable storage media). Examples of the computer-readable storage media may include magnetic storage media (e.g., ROM (Read-Only Memory), RAM (Random-Access Memory), floppy disks, hard disks, etc.) and optical reading media (e.g., CD-ROM, DVD (Digital Versatile Disc)). Computer-readable storage media may be distributed across computer systems connected, directly or indirectly, through a network, so that computer-readable code can be stored and executed in a distributed manner. A computer program may be distributed online (e.g., downloaded or uploaded) through an application store (e.g., PlayStore™) or directly between two user devices (e.g., smartphones). In the case of online distribution, at least a portion of a computer program product may be at least temporarily stored or temporarily generated in a machine-readable storage medium, such as a memory of a manufacturer's server, a server of an application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device for monitoring system load, comprising:
memory storing at least one instruction; and
at least one processor, comprising processing circuitry, configured for executing the at least one instruction,
wherein the at least one processor is individually and/or collectively configured to:
determine a priority of at least one task,
determine whether to monitor system load based on the priority of the at least one task, and
control to output monitoring data, and
wherein the system load includes at least one of CPU contention, IO wait, wake-up delay, or usage of system resource.

2. The electronic device of claim 1, wherein the at least one processor is individually and/or collectively configured to:
determine whether the priority of the at least one task is equal to or higher than a preset reference priority using a Cgroup module, in a kernel domain, and
generate the monitoring data for the system load using a system monitoring module, in a case that the priority of the at least one task is equal to or higher than the reference priority.

3. The electronic device of claim 2, wherein the at least one processor is individually and/or collectively configured to:
determine the priority of a first task and a second task via the Cgroup module, and
monitor the CPU contention between the first task and the second task, in a case that the priority of at least one of the first task or the second task is equal to or higher than the reference priority.

4. The electronic device of claim 3, wherein the at least one processor is individually and/or collectively configured to:
identify a start of CPU contention, in a case that the second task preempts a head of a run queue where the first task maintained in a running state is located,
identify an end of CPU contention, in a case that the first task is located at the head of the run queue again, and
output CPU contention monitoring data including at least one of the start of CPU contention, the end of CPU contention, the priority of the first task, or the priority of the second task.

5. The electronic device of claim 2, wherein the at least one processor is individually and/or collectively configured to:
determine the priority of the first task based on the first task generating a block IO request, and
monitor the IO wait for the first task, in a case that the priority of the first task is equal to or higher than the reference priority.

6. The electronic device of claim 5, wherein the at least one processor is individually and/or collectively configured to:
identify a start of IO wait, in a case of inserting the block IO request of the first task into an IO queue,
switch the first task to a sleep state, in a case that there is a block IO request of the second task in the IO queue,
switch the first task to a wake-up state, in a case that the block IO request of the first task in the IO queue is processed,
identify an end of IO wait, in a case that the first task is located at a head of a run queue, and
output IO wait monitoring data including at least one of the start of IO wait, the end of IO wait, the priority of the first task, or the block IO request of the first task.

7. The electronic device of claim 2, wherein the at least one processor is individually and/or collectively configured to:
determine the priority of a first task based on a wake-up request of the first task in a sleep state, and
monitor the wake-up delay for the first task, in a case that the priority of the first task is equal to or higher than the reference priority.

8. The electronic device of claim 7, wherein the at least one processor is individually and/or collectively configured to:
switch the first task to a wake-up state,
identify a start of the wake-up delay, in a case that the first task is inserted into the run queue,
identify an end of the wake-up delay, in a case that the first task is located at the head of the run queue, and
output wake-up delay monitoring data including at least one of the start of wake-up delay, the end of wake-up delay, or the priority of the first task.

9. The electronic device of claim 2, wherein the at least one processor is individually and/or collectively configured to:
monitor the usage of the system resource corresponding to the at least one task, in a case that the priority of the at least one task is equal to or higher than the reference priority, and
output system resource usage data including CPU usage within a predetermined time after system booting.

10. The electronic device of claim 9, wherein the at least one processor is individually and/or collectively configured to
sort the system resource in descending order of usage using a red-black tree (RB tree).

11. The electronic device of claim 9, wherein the at least one processor is individually and/or collectively configured to:
store command information of the at least one task in a radix tree,
update the usage of the system resource at every predetermined period, and
retrieve the system resource usage data corresponding to the command information using the radix tree, upon a request for a usage inquiry for the system resource.

12. The electronic device of claim 1, wherein the at least one processor is individually and/or collectively configured to:
perform data filtering on the monitoring data based on at least one of a type of the at least one task, the priority of the at least one task, Cgroup to which the at least one task belongs, or a magnitude of the system load, and
output the filtered monitoring data based on a user input.

13. A method for monitoring system load, the method comprising:
determining a priority of at least one task;
determining whether to monitor system load based on the priority of the at least one task; and
controlling to output monitoring data,
wherein the system load comprises at least one of CPU contention, IO wait, wake-up delay, or usage of a system resource.

14. The method of claim 13,
wherein the determining the priority of the at least one task includes determining whether the priority of the at least one task is equal to or higher than a preset reference priority using a Cgroup module, in a kernel domain; and
wherein the determining whether to monitor the system load includes generating monitoring data for the system load using a system monitoring module, in case that the priority of the at least one task is equal to or higher than the reference priority.

15. The method of claim 14,
wherein the determining the priority of the at least one task comprises determining the priority of a first task and a second task using the Cgroup module;
wherein the determining whether to monitor the system load comprises monitoring the CPU contention between the first task and the second task, in case that the priority of at least one of the first task or the second task is equal to or higher than the reference priority, and
wherein the monitoring the CPU contention comprises:
identifying a start of CPU contention, in case that the second task preempts a head of a run queue where the first task maintained in a running state is located;
identifying an end of CPU contention, in case that the first task is located at the head of the run queue again; and
generating CPU contention monitoring data including at least one of the start of CPU contention, the end of CPU contention, the priority of the first task, or the priority of the second task.

16. The method of claim 14,
wherein the determining the priority of the at least one task includes determining the priority of the first task based on the first task generating a block IO request,
wherein the determining whether to monitor the system load includes monitoring the IO wait for the first task, in a case that the priority of the first task is equal to or higher than the reference priority, and
wherein the monitoring the IO wait includes:
identifying a start of IO wait, in a case of inserting the block IO request of the first task into an IO queue;
switching the first task to a sleep state, in a case that there is a block IO request of the second task in the IO queue;
switching the first task to a wake-up state, in a case that the block IO request of the first task in the IO queue is processed;
identifying an end of the IO wait, in a case that the first task is located at a head of a run queue; and
generating IO wait monitoring data including at least one of the start of the IO wait, the end of the IO wait, the priority of the first task, or the block IO request of the first task.

17. The method of claim 14,
wherein the determining the priority of the at least one task includes determining the priority of a first task based on a wake-up request of the first task in a sleep state,
wherein the determining whether to monitor the system load includes monitoring the wake-up delay for the first task, in a case that the priority of the first task is equal to or higher than the reference priority, and
wherein the monitoring the wake-up delay includes:
switching the first task to a wake-up state;
identifying a start of the wake-up delay, in a case that the first task is inserted into the run queue;
identifying an end of the wake-up delay, in a case that the first task is located at the head of the run queue; and
generating wake-up delay monitoring data including at least one of the start of wake-up delay, the end of wake-up delay, or the priority of the first task.

18. The method of claim 14,
wherein the determining whether to monitor the system load includes monitoring the usage of the system resource corresponding to the at least one task, in a case that the priority of the at least one task is equal to or higher than the reference priority, and
wherein the monitoring the usage of the system resource includes generating system resource usage data including CPU usage within a predetermined time after system booting.

19. The method of claim 18,
wherein the monitoring the usage of the system resource includes sorting the system resource in descending order of usage using a red-black tree (RB tree).

20. The method of claim 18,
wherein the determining whether to monitor the system load includes:
storing command information of the at least one task in a radix tree;
updating the usage of the system resource at every predetermined period; and
retrieving the system resource usage data corresponding to the command information using the radix tree, upon a request for a usage inquiry for the system resource.
